(19) United States
(12) Patent Application Publication
(10) Pub. No.: US 2012/0226843 A1
(43) Pub. Date: Sep. 6, 2012

(54) Method and Computer System for Processing Data in a Memory

(76) Inventors: Wen-Tai Lin, New Taipei City (TW); Hsun Wang, New Taipei City (TW)

(21) Appl. No.: 13/180,532

(22) Filed: Jul. 11, 2011

(30) Foreign Application Priority Data
Mar. 1, 2011 (TW) 100106647

(51) Int. Cl. G06F 13/26

(52) U.S. Cl. 710/264

(57) ABSTRACT

The invention discloses a method for processing data in a memory for a computer system. The method comprises receiving a first interrupt for triggering a first job, backing up data corresponding to a second interrupt in the memory when a priority degree of the first interrupt is higher than a priority degree of the second interrupt corresponding to a second job currently being executed by the computer system, executing the first job corresponding to the first interrupt, and restoring the data corresponding to the second interrupt to the memory after the first job corresponding to the first interrupt is finished and continue executing the second job corresponding to the second interrupt.

### BACKGROUND OF THE INVENTION

1. Field of the Invention

The present invention relates to a method and computer system for processing data in a memory and more particularly, to a method and computer system for protecting integrity of data in a memory.

2. Description of the Prior Art

A memory is indispensable in a computer system, and is mainly used for storing data, software and firmware which are accessed and processed by a processor of the computer system. In general, the memory can be a write-once memory or a rewritable memory. The write-once memory, such as a read only memory (ROM), the data written into the write-once memory can only be read but not modified. On the other hand, the rewritable memory, such as a flash memory and a random access memory (RAM), the data written into the rewritable memory can be erased and new data can be written into the rewritable memory again. Comparing with the write-once memory, the rewritable memory provides greater flexibility and convenience. However, it is possible that the data written into the rewritable memory may be deleted or overwritten accidentally by other data. When the data in the memory is deleted or overwritten, an error occurs accordingly. The error may not only make a software program close, and also make the computer system crash.

A modern computer system is broadly referred to as any electronic system including a processor and a memory, such as a mobile phone and a media player, and mostly uses an interrupt to control the processor to start a job. For example, when a hardware, a software or a firmware communicates with the processor, the interrupt is generated to notify the processor to start the job or to request a result of the job from the processor. If the processor is in an idle state without executing the job, the processor immediately starts the job or replies the result of the job. Oppositely, if the processor is currently executing another job, the processor compares a priority of the interrupt corresponding to the job currently being executed with a priority of the received interrupt. If the processor determines the priority of the interrupt corresponding to the job currently being executed to be higher than the priority of the received interrupt, the processor continues executing the job currently being executed. Oppositely, if the processor determines the priority of the received interrupt to be higher than the priority of the interrupt corresponding to the job currently being executed, the processor suspends the job currently being executed and executes the job corresponding to the received interrupt. After the job corresponding to the received interrupt is finished, the processor continues executing the unfinished job. A benefit of the computer system is that when communicating with the processor, the hardware, the software or the firmware does not need to repeat busy-waiting, i.e., repeatedly generating a request and waiting for a reply to the request, but can just generate the interrupt. The processor then processes the interrupt according to above illustrated principle, and efficiency of the computer system is greatly increased.

However, whether the processor continues executing the job currently being executed, or executes the job corresponding to the received interrupt, the processor needs to access corresponding data by using the memory. If the processor executes the job corresponding to the received interrupt, the data stored in the memory may be overwritten by the data corresponding to the received interrupt, and is thus lost. In this situation, when the processor finishes the job corresponding to the received interrupt, the processor continues executing the unfinished job by using the overwritten data, and produces a wrong result possibly making the software close or the computer system crash.

Furthermore, please refer to FIG. 1, which is a schematic diagram of state transition of a memory 10 of the computer system according to the prior art. First, the memory 10 is in a state 100. The processor is executing a job corresponding to an interrupt Int_a, and needs to write data A, B, C, D and E into the memory 10 sequentially, to finish the job corresponding to the interrupt Int_a. After the processor writes the data C into the memory, i.e. , the memory 10 is in a state 102, the processor happens to receive an interrupt Int_b. The processor needs to write data W, X, Y and Z into the memory 10 sequentially, to finish a job corresponding to the interrupt Int_b. If the processor determines a priority of the interrupt Int_b to be higher than a priority of the interrupt Int_a, the processor suspends the job currently being executed, and starts to execute a job corresponding to the interrupt Int_b. Therefore, the processor starts to write the data W, X, Y and Z into the memory 10 sequentially, i.e. , the memory 10 is in a state 104. After the processor finishes the job corresponding to the interrupt Int_b, the processor continues executing the job corresponding to the interrupt Int_a, i.e., writes the data D and E into the memory 10, and the memory 10 is in a state 106. In this situation, since the data stored in the memory 10 corresponding to the interrupt Int_a is overwritten by the data corresponding the interrupt Int_b, the processor produces a wrong result of data W, X, Y, D and E after finishing the job corresponding the interrupt Int_a. To avoid this situation, the method for processing the interrupt in the computer system according to the prior art is needed to be improved.

### SUMMARY OF THE INVENTION

It is therefore the main objective of the present invention to provide a method and computer system for processing data in a memory.

A method for processing data in a memory for a computer system is disclosed. The method comprises receiving a first interrupt for triggering a first job, backing up data corresponding to a second interrupt in the memory when a priority degree of the first interrupt is higher than a priority degree of the second interrupt corresponding to a second job currently being executed by the computer system, executing the first job corresponding to the first interrupt, and restoring the data corresponding to the second interrupt to the memory after the first job corresponding to the first interrupt is finished and continue executing the second job corresponding to the second interrupt.

A computer system with stability is disclosed. The computer system comprises a processor for executing a program, a memory for storing data, and a storage device, coupled to the processor storing the program. When executed by the processor, the program instructs the processor to perform the steps of receiving a first interrupt for triggering a first job, backing up data corresponding to a second interrupt in the memory when a priority degree of the first interrupt is higher than a priority degree of the second interrupt corresponding to a second job currently being executed by the computer system; executing the first job corresponding to the first interrupt, and restoring the data corresponding to the second interrupt to the memory after the first job corresponding to the first interrupt is finished and continue executing the second job corresponding to the second interrupt.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of state transition of a memory of the computer system according to the prior art.

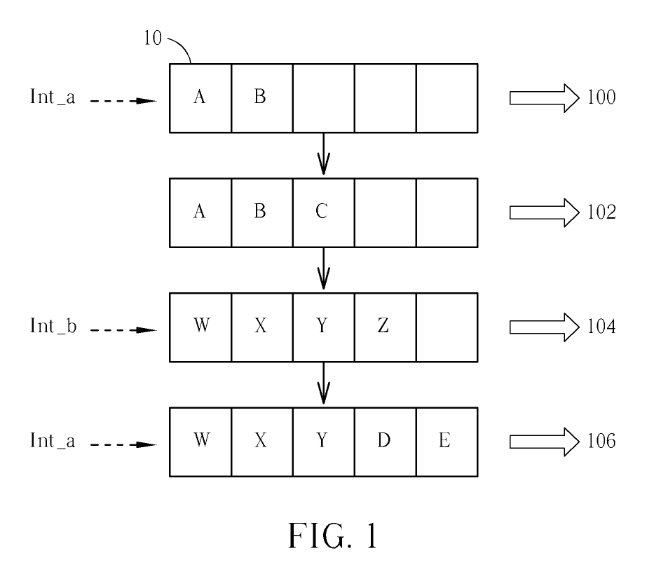

FIG. 2 is a schematic diagram of a computer system according to an embodiment of the invention.

FIG. 3 is a flowchart of a process according to an embodiment of the invention.

FIG. 4 is a schematic diagram of processing data in the memory according to the process of FIG. 3.

### DETAILED DESCRIPTION

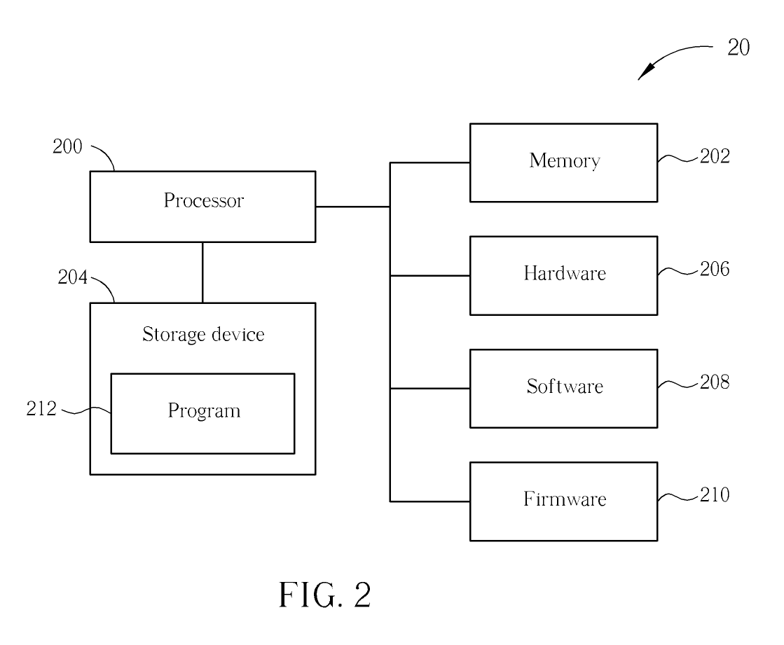

Please refer to FIG. 2, which is a schematic diagram of a computer system 20 according to an embodiment of the invention. The computer system 20 includes a processor 200, a memory 202, a storage device 204, hardware 206, software 208 and firmware 210. Further, a program 212 is stored in the storage device 204. The processor 200 is connected to the storage device 204, and executes the program 212 stored in the storage device 204 to correctly process data. The processor 200 is also connected to the memory 202, the hardware 206, the software 208 and the firmware 210, to receive interrupts generated by the hardware 206, the software 208 and the firmware 210 and to execute jobs corresponding to the interrupts. The memory 202 is used for storing the data required by the processor 200 when executing the jobs.

Please note that, FIG. 2 is used to illustrate a concept of a structure of the computer system 20 according to the invention, wherein each component device can be replaced by proper alternatives. For example, the processor 200 can be any processing unit, such as a digital signal processor (DSP) or an application-specific integrated circuit (ASIC), capable of receiving and processing the interrupts. The hardware 206 can be any computer peripheral, such as a graphics card, an input device (e.g. a keyboard or a mouse) and another storage device. The software can be an operating system or any software program of the computer system 20. Further, the firmware 210 can be a program stored in a Basic Input/Output System (BIOS) but is not limited herein.

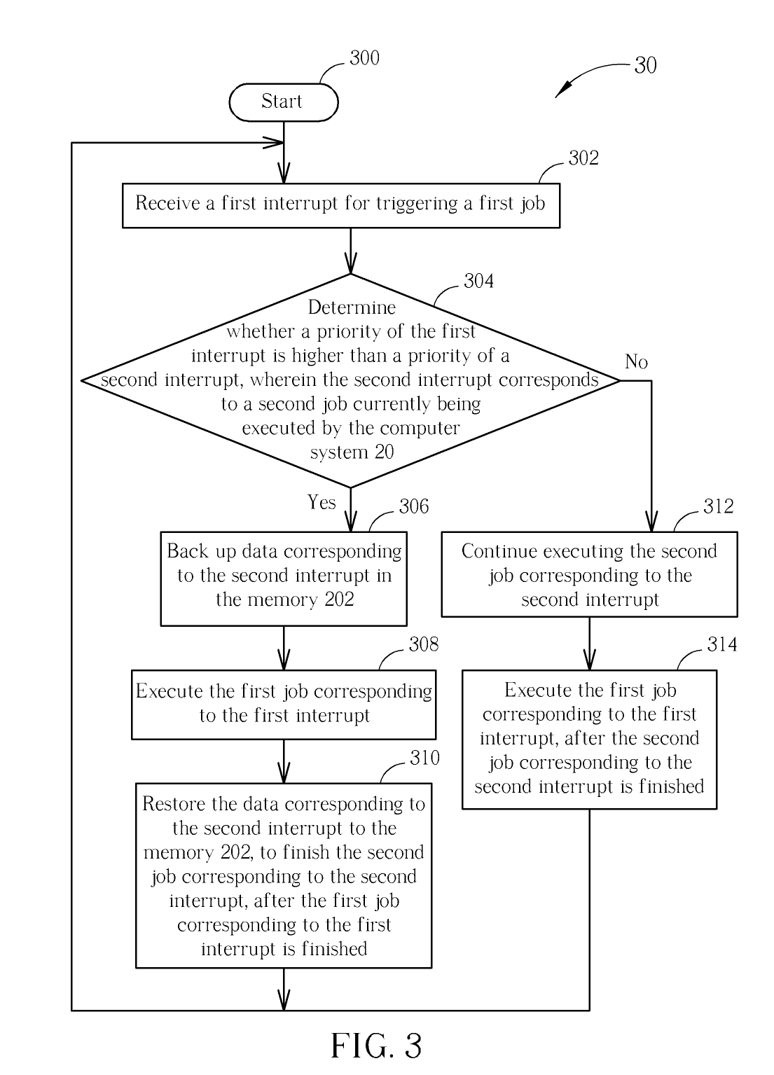

For an operation of the program 212 when processing data stored in the memory 202, please refer to FIG. 3, which is a flowchart of a process according to an embodiment of the invention. The process 30 is used for processing the data stored in the memory 202, and can be compiled into the program 212 by using commands, parameters and variables of a programming language. The process 30 includes the following steps:

Step 300: Start.

Step 302: Receive a first interrupt for triggering a first job.

Step 304: Determine whether a priority of the first interrupt is higher than a priority of a second interrupt, wherein the second interrupt corresponds to a second job currently being executed by the computer system 20. If yes, perform step 306; otherwise, go to step 312.

Step 306: Back up data corresponding to the second interrupt in the memory 202.

Step 308: Execute the first job corresponding to the first interrupt.

Step 310: Restore the data corresponding to the second interrupt to the memory 202, to finish the second job corresponding to the second interrupt, after the first job corresponding to the first interrupt is finished.

Step 312: Continue executing the second job corresponding to the second interrupt.

Step 314: Execute the first job corresponding to the first interrupt, after the second job corresponding to the second interrupt is finished.

In short, the first interrupt in the process 30 which may be generated by the hardware 206, the software 208 or the firmware 210 is a new interrupt received by the process 300. The second interrupt is the interrupt currently processed by the processor 200 before receiving the first interrupt. When the processor is executing the job corresponding to the second interrupt, the processor 200 compares the priority of the first interrupt with the priority of the second interrupt according to the invention after receiving the first interrupt. If the processor 200 determines the priority of the second interrupt to be higher than the priority of the first interrupt, the processor 200 finishes the job corresponding to the second interrupt before executing the job corresponding to the first interrupt. In this situation, the processor stores and accesses the data corresponding to the second interrupt first, and then data corresponding to the first interrupt in the memory 202. Therefore, since the processor 200 stores the data corresponding to interrupts successively, the data is not overwritten by each other and integrity of the data is protected. Please note that, priorities of interrupts cannot only be determined by the processor 200, but also the computer system 20 or a user input, and is not limited herein.

Oppositely, if the processor 200 determines the priority of the first interrupt to be higher than the priority of the second interrupt, the processor 200 suspends the job corresponding to the second interrupt, and backs up the data corresponding to the second interrupt in the memory 202. Then, the processor 200 executes the job corresponding to the first interrupt. The processor 200 restores the data corresponding to the second interrupt to the memory 202 after the job corresponding to the first interrupt is finished, and finishes the job corresponding to the second interrupt. On the other hand, if the processor 200 is in an idle state and is not executing any job when receiving the first interrupt, the processor 200 executes the job corresponding to the first interrupt immediately. In other words, the processor 200 can set the idle state as the lowest priority.

In the prior art, a processor immediately executes a job corresponding to a received interrupt and stores data corresponding to the received interrupt, if the processor determines a priority of the received interrupt to be higher than a interrupt corresponding to a job currently being executed. Therefore, it is possible that data required by the job currently being executed may be deleted or overwritten such that the job currently being executed cannot be finished with a correct result. In comparison, the invention first backs up the data required by the job currently being executed, and restores the data after the job corresponding to the received interrupt is finished. Then, the invention continues executing the unfinished job, and the problem in the prior art is avoided. Please note that, the data can be backed up in a storage location which is not occupied, especially the storage location not accessed by the job corresponding to the received interrupt, for example, another memory or a hard disk.

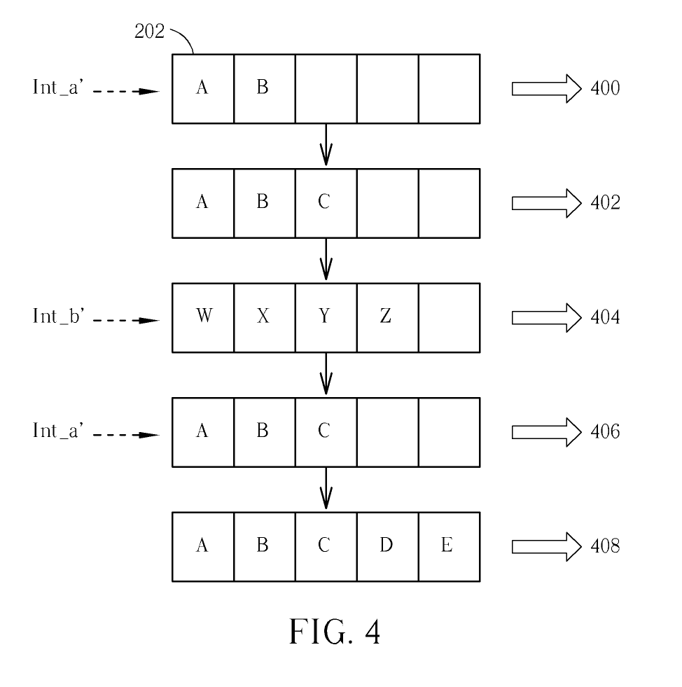

For further illustration of the invention, please refer to FIG. 4, which is a schematic diagram of processing data in the memory 202 according to the process 30 of FIG. 3. First, the memory is in a state 400. The processor 200 is executing a job corresponding to an interrupt Int_a′, and needs to write data A, B, C, D and E into the memory 202 sequentially, to finish the job corresponding to the interrupt Int_a′. After the processor 200 writes the data C into the memory 202, i.e., the memory 202 is in a state 402, the processor 200 happens to receive an interrupt Int_b′. The processor 200 needs to write data W, X, Y and Z into the memory 202 sequentially, to finish a job corresponding to the interrupt Int_b′. According to the process 30, the processor 200 compares a priority of the interrupt Int_a′ with a priority of the interrupt Int_b′. If the processor 200 determines the priority of the interrupt Int_b′ to be higher than the priority of the interrupt Int_a′, the processor 200 suspends the job corresponding to the interrupt Int_a′, and backs up the data A, B and C. Then, the processor 200 starts to execute the job corresponding to the interrupt Int_b′, and the processor 202 writes data W, X, Y and Z into the memory 202 sequentially, to finish the job corresponding to the interrupt Int_b′. After the job corresponding to the interrupt Int_b′ is finished, i.e., the memory 202 is in a state 404, the processor 200 restores the data A, B and C to the memory 202 which is then in a state 406. The processor 200 continues executing the job corresponding to an interrupt Int_a′, i.e., writing the data D and E into the memory 202, and the memory 202 is now in a state 408. As a result, the invention finishes the job correctly.

In conclusion, when receiving an interrupt higher than an interrupt corresponding to a job currently being executed, the invention backs up data required by the job currently being executed, and restores the data after a job corresponding to the received interrupt is finished. Then, the unfinished job can be executed without producing a wrong result. Therefore, the invention prevents the data from being deleted or overwritten accidentally, to correctly finish the job.

Those skilled in the art will readily observe that numerous modifications and alterations of the device and method may be made while retaining the teachings of the invention.

What is claimed is:

1. A method for processing data in a memory for a computer system, the method comprising:
receiving a first interrupt for triggering a first job;
backing up data corresponding to a second interrupt in the memory when a priority degree of the first interrupt is higher than a priority degree of the second interrupt corresponding to a second job currently being executed by the computer system;
executing the first job corresponding to the first interrupt; and
restoring the data corresponding to the second interrupt to the memory after the first job corresponding to the first interrupt is finished, and continue executing the second job corresponding to the second interrupt.

2. The method of claim 1, wherein the priority degree of the first interrupt is determined to be higher than the priority degree of the second interrupt by the computer system.

3. The method of claim 1 further comprising determining the priority degree of the first interrupt to be higher than the priority degree of the second interrupt according to a user command.

4. The method of claim 1, wherein the first interrupt and the second interrupt are respectively generated by a software program, a firmware program or a hardware device.

5. The method of claim 1, wherein the data corresponding to the second interrupt in the memory is generated when the computer system operates.

6. The method of claim 1, wherein backing up the data corresponding to the second interrupt in the memory comprises storing the data corresponding to the second interrupt in the memory in a storage location which is not occupied in the computer system.

7. The method of claim 6, wherein the storage location which is not occupied in the computer system is a storage location in the memory not occupied by the first job corresponding to the first interrupt.

8. The method of claim 6, wherein the storage location which is not occupied in the computer system is in another memory or a hard disk.

9. A computer system with stability, the computer system comprising:
a processor for executing a program;
a memory for storing data; and
a storage device, coupled to the processor storing the program;
wherein when executed by the processor, the program instructs the processor to perform the following steps:
receiving a first interrupt for triggering a first job;
backing up data corresponding to a second interrupt in the memory when a priority degree of the first interrupt is higher than a priority degree of the second interrupt corresponding to a second job currently being executed by the computer system;
executing the first job corresponding to the first interrupt; and
restoring the data corresponding to the second interrupt to the memory after the first job corresponding to the first interrupt is finished, and continue executing the second job corresponding to the second interrupt.

10. The computer system of claim 9, wherein the priority degree of the first interrupt is determined to be higher than the priority degree of the second interrupt by the computer system.

11. The computer system of claim 9 further comprising determining the priority degree of the first interrupt to be higher than the priority degree of the second interrupt according to a user command.

12. The computer system of claim 9, wherein the first interrupt and the second interrupt are respectively generated by a software program, a firmware program or a hardware device.

13. The computer system of claim 9, wherein the data corresponding to the second interrupt in the memory is generated when the computer system operates.

14. The computer system of claim 9, wherein backing up the data corresponding to the second interrupt in the memory comprises storing the data corresponding to the second interrupt in the memory in a storage location which is not occupied in the computer system.

15. The computer system of claim 14, wherein the storage location which is not occupied in the computer system is a storage location in the memory not occupied by the first job corresponding to the first interrupt.

16. The computer system of claim 14, wherein the storage location which is not occupied in the computer system is in another memory or a hard disk.
